(19) United States
(12) Patent Application Publication
(10) Pub. No.: US 2006/0169585 A1
(43) Pub. Date: Aug. 3, 2006

(54) Carbon nanotube sensor

(76) Inventors: Larry A. Nagahara, Phoenix, AZ (US); Islamshah S. Amlani, Chandler, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/048,274

(22) Filed: Jan. 31, 2005

(51) Int. Cl. G01N 27/26

(52) U.S. Cl. 204/403.1; 204/400

(57) ABSTRACT

A device is provided for determining the degree of the presence of an unwanted environmental agent. The apparatus comprises a device (30, 40) having first (31, 41) and second (33, 46) conducting layers with alternatively interdigitized fingers (34, 36, 42, 43, 44, 47, 48, 49) coupled to a nano-structure (32, 45) having a high aspect ratio, wherein sections (35, 37, 50, 51, 52, 53, 54) of the nano-structure between each of the fingers are substantially equal in length. Circuitry (62) coupled to the first and second conducting layers determines the occurrence of a change in a material characteristic of the sections of the nano-structure.

### FIELD OF THE INVENTION

The present invention generally relates to a device for determining the presence of an unwanted environmental agent, and more particularly to a nanotube device for determining the degree of the presence of the unwanted environmental agent.

### BACKGROUND OF THE INVENTION

Emergency responders, such as fire fighters, police, or HAZMAT personnel, many times arrive at the site of an emergency situation without the ability to detect environmental hazards such as toxic industrial chemicals, chemical warfare agents, or radiation. Furthermore, if it is known that an environmental hazard is present, they cannot determine the severity, or concentration, of the hazard. Such inability may result in physical harm to the emergency responders. Large quantities of toxic industrial chemicals may be present in populated areas: industrial sites, storage depots, transportation and distribution facilities, resulting in the potential for accidents such as the accidental release of methylisocyanate in Bhopal, India in 1984. Other toxic industrial chemicals, for example, include ammonia, chlorine, hydrogen chloride, and sulfuric acid. Chemical warfare agents are usually more lethal than toxic industrial chemicals. Nerve agents are the most common chemical warfare agents, such as the nerve agent Sarin that was used in the 1995 Tokyo subway gas attack. Other chemical warfare agents, for example, include Tabun, sulfur mustard, and hydrogen cyanide.

Chemical warfare agents typically are medium to high volatility and therefore may be detected in the gas phase. Electronic monitors for chemical warfare agents are based on electronic detection using ion-mobility-spectrometry, photo-ionization and flame-ionization. These tools offer a broadband response with high levels of sensitivity, but most suffer from interference effects caused by what is often a highly complex chemical background mix at the scene, and most commercial tools exhibit high false-positive responses to contaminants. Furthermore, these devices are not designed to be wearable, and most tools, although handheld, are relatively bulky and fully engage the user, thereby detracting from other important duties.

Known colorimetric methods for detecting such chemical and biological hazards include simple color-change badges generally having a life span of approximately 8 hours, to tubes providing quantitative data with high specificity, but both require the user to assess the color change to determine the hazard level. Furthermore, gas tubes are sensitive to physical abuse and are limited in some cases to only one or in other cases a few hazards requiring the user to know what type or types of hazards are suspected.

Radiological threats have become more relevant with the so-called ‘dirty bomb’, which combines explosive blast with surreptitious ingredients of radionuclides such as Cs-137, a beta and gamma emitter. Radiological monitors (dosimeters) have been available for many years, mostly for occupational safety monitoring. Pager style, wearable units, having audio/visual alerts built-in are available for such monitoring. Also, a variety of miniature radiation detectors exist, such as small Geiger-Muller tubes, selective scintillation layers with photo-sensors, and silicon diodes. Probes can be attached to other types of monitors, covering any of the radiation species, but these monitors are at best hand-held, and must be maintained regularly. Recently, colorimetric badges that detect radiation have been developed; however, these require the user to constantly monitor its status.

Carbon is one of the most important known elements and can be combined with oxygen, hydrogen, nitrogen and the like. Carbon has four known unique crystalline structures including diamond, graphite, fullerene and carbon nanotubes. In particular, carbon nanotubes refer to a helical tubular structure grown with a single wall or multi-wall, and commonly referred to as single-walled nanotubes (SWNTs), or multi-walled nanotubes (MWNTs), respectively. These types of structures are obtained by rolling a sheet formed of a plurality of hexagons. The sheet is formed by combining each carbon atom thereof with three neighboring carbon atoms to form a helical tube. Carbon nanotubes typically have a diameter in the order of a fraction of a nanometer to a few hundred nanometers.

Carbon nanotubes can function as either a conductor, like metal, or a semiconductor, according to the rolled shape and the diameter of the helical tubes. With metallic-like nanotubes, it has been found that a one-dimensional carbon-based structure can conduct a current at room temperature with essentially no resistance. Further, electrons can be considered as moving freely through the structure, so that metallic-like nanotubes can be used as ideal interconnects. When semiconductor nanotubes are connected to two metal electrodes, the structure can function as a field effect transistor wherein the nanotubes can be switched from a conducting to an insulating state by applying a voltage to a gate electrode. Therefore, carbon nanotubes are potential building blocks for nanoelectronic devices because of their unique structural, physical, and chemical properties.

Existing methods for the production of nanotubes, include arc-discharge and laser ablation techniques. Unfortunately, these methods typically yield bulk materials with tangled nanotubes. Recently, reported by J. Kong, A. M. Cassell, and H Dai, in Chem. Phys. Lett. 292, 567 (1988) and J. Hafner, M. Bronikowski, B. Azamian, P. Nikoleav, D. Colbert, K. Smith, and R. Smalley, in Chem. Phys Lett. 296, 195 (1998) was the formation of high quality individual single-walled carbon nanotubes (SWNTs) demonstrated via thermal chemical vapor deposition (CVD) approach, using Fe/Mo or Fe nanoparticles as a catalyst. The CVD process has allowed selective growth of individual SWNTs, and simplified the process for making SWNT based devices. However, the choice of catalyst materials that can be used to promote SWNT growth in a CVD process has been limited to only Fe/Mo nanoparticles. Furthermore, the catalytic nanoparticles were usually derived by wet chemical routes, which are time consuming and difficult to use for patterning small features.

Another approach for fabricating nanotubes is to deposit metal films using ion beam sputtering to form catalytic nanoparticles. In an article by L. Delzeit, B. Chen, A. Cassell, R. Stevens, C. Nguyen and M. Meyyappan in Chem. Phys. Lett. 348, 368 (2002), CVD growth of SWNTs at temperatures of 900° C. and above was described using Fe or an Fe/Mo bi-layer thin film supported with a thin aluminum under layer. However, the required high growth temperature prevents integration of CNTs growth with other device fabrication processes.

Single walled carbon nanotubes have been shown to be a highly sensitive chemical and biological sensor. The utility of detecting the presence or absence of a specific agent is one type of known detection scheme. As the agent attaches itself to a nanotube, the measurable resistance of the nanotube changes. As the resistance changes, a quantitative result, e.g., concentration, may be determined. Known nanotube systems use a single nanotube (only one path for determining resistance), a parallel array of nanotubes, or a network array of nanotubes to determine the presence of an unwanted agent.

However, known nanotube systems do not provide a dynamic range that spans several orders of magnitude. An accurate method is needed that gives a greater degree of accuracy and reliability.

Accordingly, it is desirable to provide a device for determining the degree of the presence of an unwanted environmental agent. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A device is provided for determining the degree of the presence of an unwanted environmental agent. The apparatus comprises a device having first and second conducting layers with alternatively interdigitized fingers coupled to a nano-structure having a high aspect ratio, wherein sections of the nano-structure between each of the fingers are substantially equal in length. Circuitry coupled to the first and second conducting layers determines the occurrence of a change in a measurable characteristic of the sections of the nano-structure.

### BRIEF DESCRIPTION OF THE DRAWINGS

The present invention will hereinafter be described in conjunction with the following drawing figures, wherein like numerals denote like elements, and

FIG. 1 is a schematic of a known device including electrodes across two nano-structure;

FIG. 2 is a schematic of a known device including electrodes across five nano-structure;

FIG. 3 is a schematic of a first embodiment of the present invention;

FIG. 4 is a schematic of a second embodiment of the present invention; and

FIG. 5 is a block diagram of another embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

When a molecule attaches itself to a nano-structure, such as a carbon nanotube, a characteristic of the material changes, such as the change in a current flowing in the nanotube that is measurable in a manner known to those skilled in the art. While a carbon nanotube is the preferred embodiment of the nano-structure, other embodiments would include all other nano-structures with a high aspect ratio (length versus width), for example, carbon fibers, metal nanowires, semiconductor nano-wires, nano-ribbons, and tubes formed with other materials such as boron nitride. Additionally, the nano-structure may be coated with a substance for determining specific environmental agents. And while a change in current is the preferred embodiment for the measurable material characteristic, other embodiments would include, for example, magnetic, optical, frequency, and mechanical.

By measuring this change in the current, it is known that a determination may be made as to the number of molecules that have attached to the carbon nanotube, and therefore, a correlation to the concentration of the molecules in the environment around the carbon nanotube. Known systems place an electrode across a carbon nanotube to measure this change in the material characteristic.

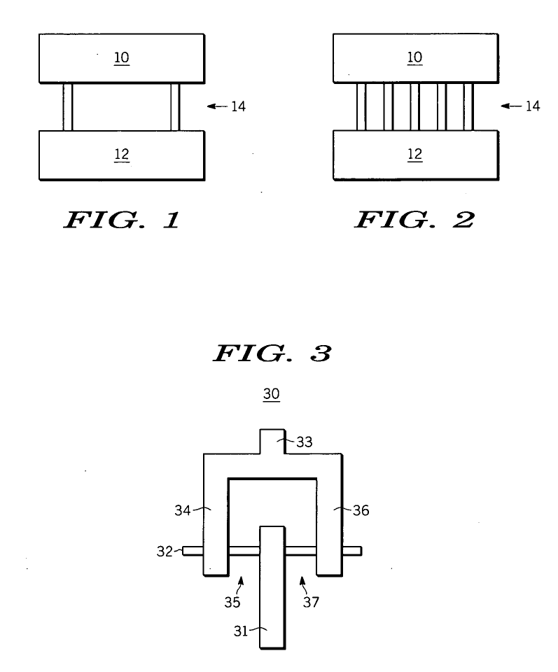

However, since a single section of a nanotube may not provide enough area for a sufficient reading, several sections of a plurality of nanotubes are positioned across the pair of electrodes. For example, FIG. 1 illustrates electrodes 10 and 12 coupled across two nanotubes 14, and FIG. 2 illustrates electrodes 10 and 12 coupled across five nanotubes 14. However, when several nanotubes are placed in parallel, the length (since they are rarely parallel) and diameter of each nanotube will vary. Additionally, the number of nanotubes coupled between electrodes may not be known. This results in an inaccurate and non-standard reading.

Referring to FIG. 3, a cross section of a first embodiment of the present invention comprises a device 30 including a first electrode 31 electrically coupled to a nanotube 32. A second electrode 33 includes a first arm 34 electrically coupled to the nanotube 32, thereby defining a first portion 35 of nanotube 32 between the electrode 31 and the first arm 34. A second arm 36 of the second electrode 33 is electrically coupled to the nanotube 32, thereby defining a second portion 37 of nanotube 32 between the electrode 31 and the second arm 36. By using two sections of the same nanotube 32, the diameter will be the same and since the nanotube will be substantially straight and the first and second arms 34 and 36 will be equally spaced on either side of electrode 31, the sections will be the same length.

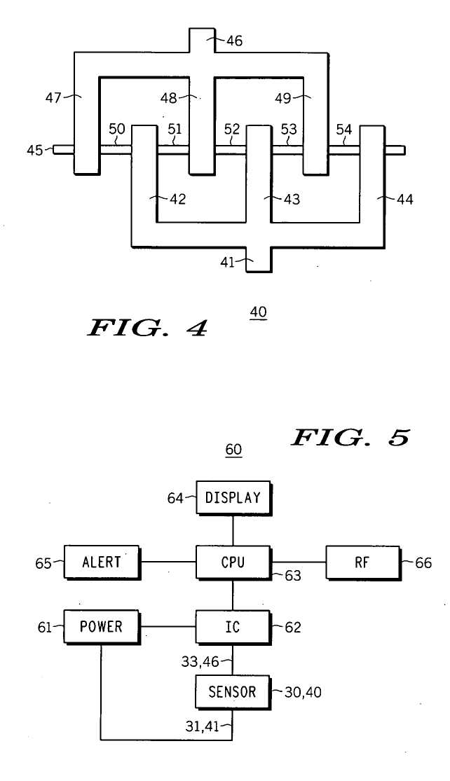

While only two sections 35 and 37 of the nanotube 32 are shown in FIG. 3, it should be understood that any number of sections could be used. See for example FIG. 4, where device 40 comprises a first arm 41 having three arms 42, 43, and 44 equally spaced apart and making electrical contact with nanotube 45. A second arm 46 comprises arms 47, 48, and 49 equally spaced and making electrical contact with nanotube 45. Each of the arms 42, 43, 44, 47, 48, and 49 cooperate to define nanotube sections 50, 51, 52, 53, and 54.

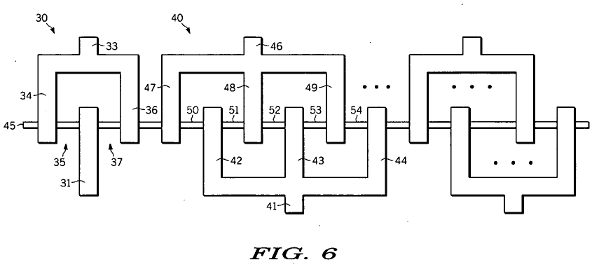

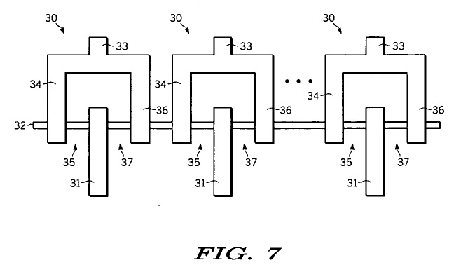

Referring to FIG. 5, an exemplary system 60 includes the device 30 or 40, for example, having their electrodes 31 and 33, or 41 and 46 coupled to a power source 61, e.g., a battery. A circuit 62 determines the current between the electrodes and supplies the information to a processor 63. The information may be transferred from the processor 63 to a display 64, an alert device 65, or an RF transmitter 66.

The nanotubes 32 and 45 may be grown in any manner known to those skilled in the art, and are typically 100 nm to 1 cm in length and less than 1 nm to 100 nm in diameter. The conductive layers, or electrodes 31, 33, 41, and 46, may comprise any conductive material, but preferably would comprise layers of chromium and gold, titanium and gold, palladium, or gold. Contact between the nanofubes 32 and 45 and electrodes 31, 33, 41, and 46 is made during fabrication, for example, by any type of lithography, e-beam, optical, soft lithography, or imprint technology.

Referring to FIG. 6, the use of an increasing number of interdigited finger devices gives the ability to determine the concentration range of the environmental agent. Placing the device 30 and device 40 on the same nanostructure allows for a determination of the concentration level of the environmental agent. Having many more devices with 7, 9, 11, . . . N fingers, where N corresponds to the highest concentration value to be measured, allows for a more accurate determination of the concentration value. For a given concentration, the devices with the smaller number of fingers will saturate (maximum possible reading) before the devices with larger number of fingers. For example, sequential reading of the devices in an ascending order until determining that a device has not saturated will indicate the concentration of the environmental agent.

Referring to FIG. 7, multiples of one device having the same number of fingers, e.g., device 30, on the same nano-structure provide better stringency (precision). Therefore, the preferred embodiment would have devices with, for example, 3, 3, . . . x; 5, 5, . . . y; 7, 7, z . . . N, where x, y, and z are determined based on the desired stringency. Having multiple devices with the same number of fingers allows for averaging the reading from each device, resulting in a more precise reading of the presence of the environmental agent.

The sensor described herein provides a larger dynamic sensitivity range while not degrading any of the performance due to variations in the sensing element by sensing the current through sections of the same long nanotube, thereby eliminating the need to make shorter nanotubes identical in diameter and chirality. A single long nanotube has the same diameter and chirality along its entire length. Dynamic range, or the ability to accurately detect the number of agents in the environment, is thereby increased.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A device comprising:
a nano-structure having a material characteristic and a high aspect ratio;
first and second conducting layers having alternatively interdigitized fingers, the fingers coupled to the nano-structure, wherein sections of the nano-structure between each of the fingers are substantially equal in length, and
circuitry coupled to the first and second conducting layers for determining a measurable change in the material characteristic of the sections of the nano-structure.

2. The device of claim 1 wherein the nano-structure comprises a carbon nanotube.

3. The device of claim 1 wherein the material characteristic is a current flowing from the first conducting layer through the nano-structure to the second conducting layer.

4. The device of claim 1 wherein the nano-structure is one of a carbon nanotube, carbon fibers, metal nanowires, semiconductor nano-wires, nano-ribbons, and tubes.

5. The device of claim 1 wherein the material characteristic comprises one of electrical, magnetic, optical, frequency, and mechanical.

6. The device of claim 1 further comprising third and fourth conducting layers having alternatively interdigitized fingers, the fingers coupled to the nano-structure, wherein sections of the nano-structure between each of the fingers are substantially equal in length, the circuitry coupled to the third and fourth conducting layers for determining a measurable change in the material characteristic of the sections of the nano-structure.

7. A device comprising:
a nano-structure having a high aspect ratio;
a first conducting material having first and second fingers, each of the fingers intersecting the nano-structure;
a second conducting material having a third finger intersecting the nano-structure at a position between where the first and second fingers intersect the nano-structure, wherein a first section of the nano-structure between the first and third fingers is substantially equal in length to a second section of the nano-structure between the second and third fingers; and
circuitry coupled to the first and second conducting material for determining a measurable change in the material characteristic in either of the first and second sections.

8. The device of claim 7 wherein the nano-structure comprises a carbon nanotube.

9. The device of claim 7 wherein the material characteristic is a current flowing from the first conducting material through the nano-structure to the second conducting material.

10. The device of claim 7 wherein the nano-structure is one of a carbon nanotube, carbon fibers, metal nanowires, semiconductor nano-wires, nano-ribbons, and tubes.

11. The device of claim 7 wherein the material characteristic comprises one of electrical, magnetic, optical, frequency, and mechanical.

12. The device of claim 7 further comprising:
a third conducting material having fourth and fifth fingers, each of the fingers intersecting the nano-structure; and
a fourth conducting material having a sixth finger intersecting the nano-structure at a position between where the fourth and fifth fingers intersect the nano-structure, wherein a third section of the nano-structure between the fourth and sixth fingers is substantially equal in length to a fourth section of the nano-structure between the fifth and sixth fingers, the circuitry coupled to the first and second conducting material for determining a measurable change in the material characteristic in either of the third and fourth sections.

13. The device of claim 7 further comprising:
a third conducting material having more than two fingers, each of the fingers intersecting the nano-structure; and
a fourth conducting material having more than one finger, each one of the more than one fingers intersecting the nano-structure at a position between where each of the more than two fingers intersect the nano-structure, wherein each of sections of nano-structure between each of the fingers are substantially equal in length, the circuitry coupled to the third and fourth conducting material for detecting a change in the current in either of the third and fourth sections.

14. The device of claim 13 further comprising:
a fifth conducting material having more than two fingers, each of the fingers intersecting the nano-structure; and
a sixth conducting material having more than one finger, each one of the more than one fingers intersecting the nano-structure at a position between where each of the more than two fingers intersect the nano-structure, wherein each of sections of nano-structure between each of the fingers are substantially equal in length, the circuitry coupled to the fifth and sixth conducting material for detecting a change in the current in either of the fifth and sixth sections.

15. A device comprising:
a nano-structure having a high aspect ratio;
a first conducting material having a first plurality of fingers intersecting the nano-structure;
a second conducting material having a second plurality of fingers, each alternatively intersecting the nano-structure at a position between where each of the first plurality of fingers intersect the nano-structure, wherein each section of the nano-structure between the alternating fingers is substantially equal in length; and
circuitry coupled to the first and second conducting material for measuring a change of a material characteristic of the nano-structure when exposed to an environmental agent.

16. The device of claim 15 wherein the nano-structure comprises a carbon nanotube.

17. The device of claim 15 wherein the material characteristic is a current flowing from the first conducting layer through the nano-structure to the second conducting layer.

18. The device of claim 15 wherein the nano-structure is one of a carbon nanotube, carbon fibers, metal nanowires, semiconductor nano-wires, nano-ribbons, and tubes.

19. The device of claim 15 wherein the material characteristic comprises one of electrical, magnetic, optical, frequency, and mechanical.

20. The device of claim 15 further comprising:
a third conducting material having a third plurality of fingers intersecting the nano-structure;
a fourth conducting material having a fourth plurality of fingers, each alternatively intersecting the nano-structure at a position between each of the third plurality of fingers intersect the nano-structure, wherein each section of the nano-structure between the alternating fingers is substantially equal in length, the circuitry coupled to the third and fourth conducting material for measuring a change in a material characteristic of the nano-structure when exposed to an environmental agent
